(19) United States
(12) Patent Application Publication
(10) Pub. No.: US 2002/0112184 A1
(43) Pub. Date: Aug. 15, 2002

(54) System and method for secure transmission of data clients

(76) Inventors: John M. Hall, Boise, ID (US); Steve Mattis, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/783,802

(22) Filed: Feb. 12, 2001

(51) Int. Cl. G06F 11/30; H04L 9/00

(52) U.S. Cl. 713/201; 709/206

(57) ABSTRACT

A system and method are provided to perform a secure transfer of a digital document to a number of recipients. The system includes a processor circuit having a processor and a memory and a digital sender service stored on the memory and executable by the processor. The digital sender service comprises, for example, logic to map from a number of destination addresses to a respective number of security identifiers, and, logic to add a number of access privileges to the digital document via a network using the security identifiers. The digital sender service also includes logic to post the digital document on a server accessible via the network. In addition, the digital sender service includes logic to generate and transmit a number of email messages to the corresponding number of destination addresses on the network. The email messages include a uniform resource locator of the digital document on the network.

### TECHNICAL FIELD

The present invention is generally related to the field of multi-function peripherals and, more particularly, is related to a system and method for the secure transmission of data to one or more clients.

### BACKGROUND OF THE INVENTION

Document handling technology has begun the task of integrating the functions of a printer, a scanner, and a copy machine into single multi-function peripherals. In an office environment, such multi-function peripherals are often linked to a computer or a network to enable users to print documents from their computers on the same network. Also individuals may use the multi-function peripheral, for example, as the office copy machine, a printer, or as a scanner, etc.

In addition, multi-function peripherals may also include a digital sender to transmit documents via electronic mail, facsimile, or other transmitting mechanism. In an office environment, the digital sending functionality of a multi-function peripheral provides a public point of access for transmission of documents. That is to say, that multiple parties can employ the multi-function peripheral to scan a document for transmission to one or more third parties. This functionality differs from the electronic mail function, for example, of a typical computer in an office environment in that the computer is usually assigned to a particular individual, often times with limited access to the computer by requiring passwords, etc.

In those cases where a user employs the multi-function peripheral to scan and send a document, for example, to a number of individuals, a significant burden may be placed on the electronic mail handling devices associated with the network. Assume, for example, that a very large document is to be transmitted to a number of individuals via electronic mail. Inevitably, the electronic mail system must send several copies of the same large document to the multiple recipients. This translates into a significant and undesirable load on the average electronic mail system.

### SUMMARY OF THE INVENTION

In light of the foregoing, a system and method are provided to perform a secure transfer of a digital document to a number of recipients. In one embodiment, the system includes a processor circuit having a processor and a memory and a digital sender service stored on the memory and executable by the processor. The digital sender service comprises, for example, logic to map from a number of destination addresses to a respective number of security identifiers, and, logic to add a number of access privileges to the digital document via a network using the security identifiers.

The digital sender service also includes logic to post the digital document on a server accessible via the network. In addition, the digital sender service includes logic to generate and transmit a number of email messages to the corresponding number of destination addresses on the network. Each of the email messages includes a uniform resource locator of the digital document on the network. Recipients of the email addresses can access the digital document on the server using, for example, a browser. When an individual seeks access to the digital document on the server, access is denied if their associated security identifier is not listed in the access control list (ACL) of the digital document.

In another embodiment, the present invention also provides for a method for performing a secure transfer of a digital document to a number of recipients. The present method includes the steps of: mapping from a number of destination addresses to a respective number of security identifiers via a directory server, adding a number of access privileges to the digital document in a computer system via a network using the security identifiers, and, posting the digital document on a server accessible via the network. The present method also includes, for example, the steps of generating a number of email messages to be transmitted to the number of destination addresses, respectively, associating a uniform resource locator of the digital document on the network with each of the email messages, and, transmitting the email messages to the respective destination addresses on the network.

The present invention also provides for a computer program embodied on a computer readable medium for transferring a digital document. In this respect, the computer program comprises logic to map from a number of destination addresses to a respective number of security identifiers, logic to add a number of access privileges to the digital document via a network using the security identifiers, and, logic to post the digital document on a server accessible via the network. The computer program further comprises logic to generate a number of email messages to be transmitted to the number of destination addresses, respectively, logic to associate a uniform resource locator of the digital document on the network with each of the email messages, and, logic to transmit the email messages to the respective destination addresses on the network.

Other features and advantages of the present invention will become apparent to a person with ordinary skill in view of the following drawings and detailed description. It is intended that all such additional features and advantages be included herein within the scope of the present invention.

### BRIEF DESCRIPTION OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of an office network, for example, according to the present invention;

FIG. 2 is a flow chart of a digital sender stored and executed in a multi-function peripheral of the office network of FIG. 1; and

FIG. 3 is a flow chart of a digital sender service stored and executed in a server in the office network of FIG. 1.

### DETAILED DESCRIPTION OF THE INVENTION

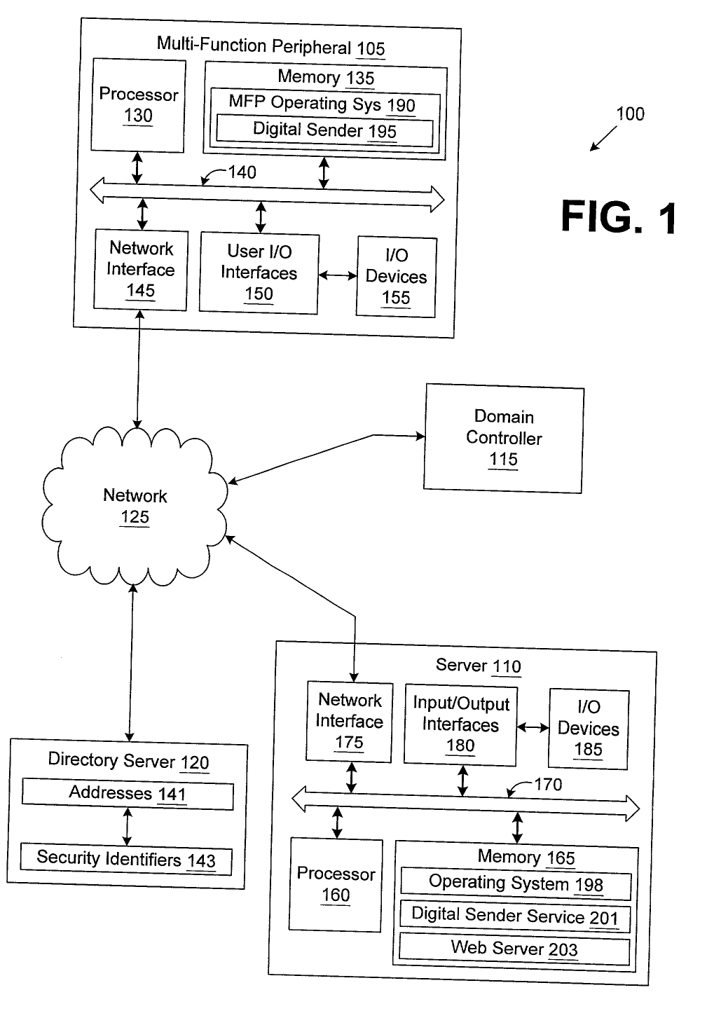

With reference to FIG. 1, shown is an office network 100, for example, according to the present invention. The office network 100 includes a multi-function peripheral (MFP) 105, a server 110, a domain controller 115, and a directory server 120. The MFP 105, server 110, domain controller 115, and the directory server 120 are all coupled to a network 125 and are in data communication with each other via the network 125. The MFP 105 performs, for example, the functions of a copier, printer, and a scanner. The MFP 105 includes a processor circuit to implement and control copy, print, and scan functions. The processor circuit includes a processor 130 and a memory 135, both of which are coupled to a local interface 140. The local interface 140 may be a data bus with an accompanying control bus as known by those with ordinary skill in the art.

The domain controller 115 and the directory server 120 may be implemented in their own computer systems, for example, or they may be implemented in the server 110, etc. The specific operation of the domain controller 115 and the directory server 120 is generally known to those with ordinary skill in the art. The directory server 120 generally employs a lightweight directory access protocol to facilitate interaction with the other devices on the network 125. The directory server 120 includes a number of addresses 141 of a number of devices on the network 125 and a corresponding number of security identifiers 143 that are stored in memory therein. Each of the addresses 141 is mapped to a corresponding one of the security identifiers 143 using, for example, a lookup table. The addresses 141 may, for example, email addresses or other address on the network 125.

The MFP 105 also includes a network interface 145 that couples the local interface 140 to the network 125. The network interface 145 may be, for example, an interface card or other interface that includes appropriate buffer or other circuitry that links the local interface 140 to the network 125 based upon the data communications protocol of the network 125. In addition to the network interface 145, the MFP 105 also includes input/output interfaces 150 that couple the local interface 140 with a number of input/output devices 155. The input/output devices 155 may include user input devices such as, for example, a keypad, touch pad, touch screen, microphone, mouse, joystick, one or more push buttons, or scanners, etc. User output devices may include display devices, speakers, printers, etc. The display devices may encompass, for example, a cathode ray tube (CRT), a liquid crystal display screen, a gas plasma-based flat panel display, indicator lights, light emitting diodes, and other display devices. Other user input/output devices 155 beyond those listed above may be employed as well. There are also other input/output devices that are controlled by the processor 130 that perform the various functions of the MFP 105 including motors and other equipment, etc., as is known by those of ordinary skill in the art.

The server 110 also includes a processor circuit with a processor 160 and a memory 165, both of which are coupled to a local interface 170. Similar to the local interface 140, the local interface 170 may be a data bus with an accompanying control bus as known by those with ordinary skill in the art. The local interface 170 is coupled to the network 125 by a network interface 175. Also, the server 110 may include one or more input/output devices 180 that are linked to the local interface 170 by one or more input/output interfaces 185. The input/output devices 180 may include, for example, devices similar to the input/output devices 155 discussed above.

According to an aspect of the present invention, the network 125 is a local area network (LAN) or other similar network that are generally known to those with ordinary skill in the art. In such a case, the network 125 is coupled, for example, to the Internet, a wide area network, or other such network via an appropriate gateway or other suitable device. Alternatively, the network 125 may include, for example, the Internet, wide area networks (WANs), local area networks, or other suitable networks, etc., or any combination of two or more such networks. The MFP 105, server 110, directory server 120, and domain controller 115 are each coupled to the network 125 in any one of a number of ways to facilitate data communication to and from the network 125 as is generally known by those of ordinary skill in the art.

In addition, the processors 130/160 may represent multiple processors and the memories 135/165 may represent multiple memories that operate in parallel. In such a case, the local interfaces 140/170 may be an appropriate network that facilitates communication between any two of the multiple processors or between any processor and any of the memories, etc. The local interfaces 140/170 may facilitate memory to memory communication as well. The processors 130/160, memories 135/165, and local interfaces 140/170 may be electrical or optical in nature. Also, the memories 135/165 may be magnetic in nature.

The memories 135/165 may include both volatile and nonvolatile memory components. Volatile components are those that do not retain data values upon loss of power. Nonvolatile components are those that retain data upon a loss of power. Thus, the memories 135/165 may comprise, for example, random access memory (RAM), read-only memory (ROM), hard disk drives, floppy disks accessed via an associated floppy disk drive, compact disks accessed via a compact disk drive, magnetic tapes accessed via an appropriate tape drive, and/or other memory components, or a combination of any two or more of these memory components.

The MFP 105 also includes an MFP operating system 190 that is stored on the memory 135 and executable by the processor 130. The MFP operating system 190 includes a digital sender 195 that is executed to transmit a document from the MFP 105 to another device on the network 125 or to a device on an external network, for example, through a standard mail transfer protocol server (SMTP) (not shown) coupled to the network 125. Among other functionality, the digital sender 195 is executed to identify the email addresses 141 of a number of recipients of a digital document scanned in from a hardcopy document with the multi-function peripheral 105. The digital sender 195 is also executed to send the digital document to another device on the network 125.

The server 110 includes an operating system 198, a digital sender service 201, and a web server 203. The operating system 198 is stored on the memory 165 and executable by the processor 160 to provide for the functionality of the server 110 in its general role on the network 125 as is known by those of ordinary skill in the art. The digital sender service 201 is stored on the memory 165 and executable by the processor 160 to transmit a digital document to a number of recipients on either the network 125 or an external network that is coupled to the network 125. For example, the digital sender service 201 may transmit a document to various recipients by posting the document on the web server 203 and provide access thereto to selected recipients as will be discussed.

The web server 203 makes documents available on the World Wide Web as is generally known by those skilled in the art where the network 125 is linked to an external network such as, for example, the Internet. In cases where the network 125 is not coupled to an external network, then the documents or other information stored on the web server 203 may be accessed by the various devices on the network 125 using appropriate browsers as is generally known by those with ordinary skill in the art. In addition, the web server 203 is not restricted to operation on the World Wide Web. Specifically, the web server 203 may be a server that operates with other networking systems.

Next a general discussion of the operation of the MFP 105 and the server 110 in the context of a specific scanning and sending task is given to provide an overview of the various aspects of the present invention. To begin, a user wishes to use the MFP 105 to scan a hardcopy document into a digital document and then send the digital document to a number of recipients over the network 125. The user enters a number of destination email addresses 141 of the intended recipients of the digital document into the MFP 105 and then initiates a send function where the digital document is distributed via email to the intended recipients. In doing so, the actual digital document is not transmitted to each recipient, but is posted on the web server 203 to be accessed by those recipients for which a destination email address 141 was entered.

Specifically, the digital sender 195 of the MFP 105 sends the digital document and the list of destination email addresses 141 to the digital sender service 201 of the server 110. The digital sender service 201 converts the digital document received from the digital sender 195 into a format that may be accessed via the web server 203. The digital sender service 201 then copies the digital document to the web server 203 where it may be accessed by the various devices coupled to the network 125, etc.

Next, the digital sender service 201 allows access to the digital document stored on the web server 203 to selected recipients by adding read file privileges in the access control list of the digital document. This is accomplished by associating the security identifier 143 for each appropriate recipient with the digital document. Specifically, the respective security identifiers 143 are listed in the access control list of the digital document. To accomplish this, the digital sender service 201 needs the security identifiers 143 associated with each of the destination email addresses 141 received from the digital sender 195.

This is achieved by mapping each of the destination email addresses 141 to a respective security identifier 143. Specifically, each of the destination email addresses 141 is sent to the directory server 120 along with a request for the security identifier 143 associated therewith. The requests are formatted according to a lightweight directory access protocol (LDAP) or other suitable protocol employed to access the information contained in the directory server 120. For each request, the directory server 120 then looks up the specific security identifier 143 and sends it back in a reply to the digital sender service 201.

Thereafter, the digital sender service 201 generates and transmits an email message to each of the intended recipients of the digital document based on the destination email addresses 141. A uniform resource locator (URL) that provides the location of the digital document on the web server 203 is associated with each of the email messages. Each of the email messages informs the recipient that they may access the digital document at the URL.

Each of the recipients may access the digital document based on the URL using, for example, a browser on a client device such as, for example, a computer system or other device that is coupled to the network 125. When accessing the digital document stored on the web server 203, the client device is authenticated using various techniques that are generally known by those with ordinary skill in the art. In requesting access to the digital document, the client device transmits the associated user identifier that may comprise, for example, the username and domain name to the web server 203 to perform the authentication. During the authentication process, the web server 203 may send, for example, the user identifier and/or other credentials to the domain controller 115 (FIG. 1) with a request for the associated security identifier 143 according to the lightweight directory access protocol. The directory server 120 responds with the associated security identifier 143. The web server then compares the security identifier 143 with those stored in the access control list of the digital document to determine who has access thereto. If the client has access, then the digital document is transmitted to the client accordingly.

The present invention provides a distinct advantage in that a document may be made accessible only to a predefined number of recipients using existing networking technology. This is accomplished while minimizing the transmission load on an email server or other similar device. In addition, as employed herein, the terms “digital document” refer to any type of digital file. Thus, the digital document may be, for example, a document generated by a word processor, a spreadsheet, data file, or a file employing any other data format for a particular application.

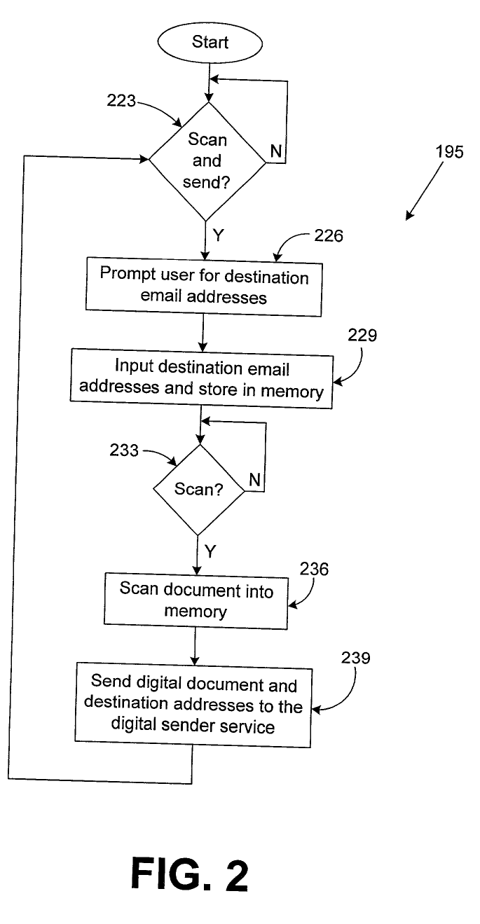

Turning to FIG. 2, shown is a flow chart of a portion of the functionality of the digital sender 195 according to an aspect of the present invention. Alternatively, the flow chart of FIG. 2 may be viewed as a method performed in the MFP 105 (FIG. 1). The flow chart of FIG. 2 illustrates the functionality of the digital sender 195 in scanning a hardcopy document to create a digital document that is then transmitted to another device on the network 125. It is understood that the digital sender 195 may include other functionality beyond that described herein.

Beginning with block 223, the digital sender 195 waits for a hardcopy document to be scanned and sent to a particular destination in digital form. If such is the case, then the digital sender 195 moves to block 226 in which the user is prompted to enter the destination email addresses 141 (FIG. 1) of the intended recipients of the digital document. This may be accomplished, for example, by displaying a particular message on a display device. Thereafter, in block 229 the digital sender 195 receives and stores the destination email addresses 141 as input that is entered by the user via a touch pad or other input device.

Then, in block 233, the digital sender 195 waits until the user initiates the scanning function by manipulating an appropriate input device such as, for example, a pushbutton, etc. In block 236, the digital sender 195 directs the MFP 105 to scan the hardcopy document to generate the counterpart digital document that is stored in the memory 135 (FIG. 1). Thereafter, in block 239 the digital sender 195 transmits the digital document and the destination email addresses 141 of the intended recipients to the digital sender service 201 (FIG. 1) in the server 110 (FIG. 1) via the network 125 (FIG. 1). The digital sender 195 then reverts back to block 223 to wait for the next document to scan and send accordingly.

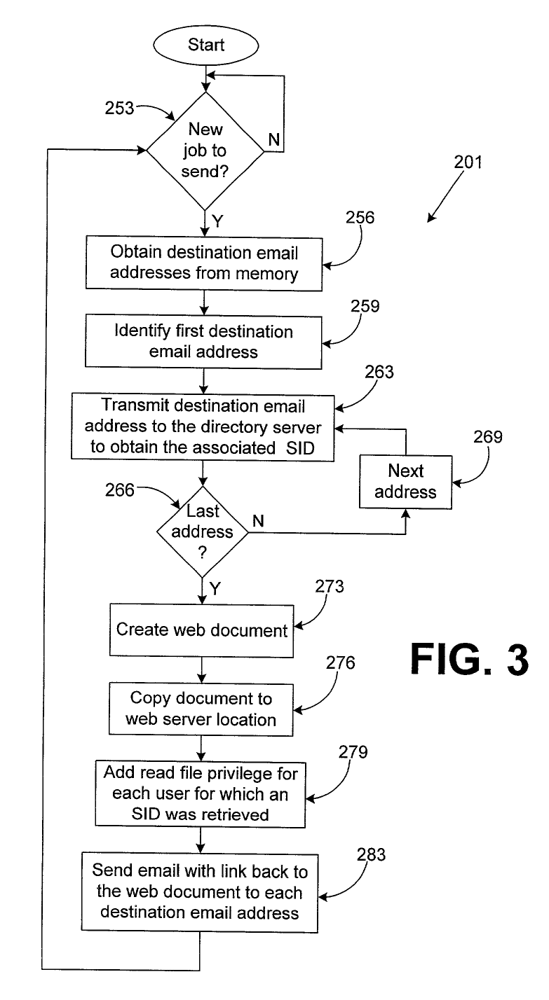

With reference to FIG. 3, shown is a flow chart of the digital sender service 201 according to an aspect of the present invention. Alternatively, the flow chart of FIG. 3 may be viewed as a method performed in the server 110 (FIG. 1). The digital sender service 201 is executed to provide a digital document received from the MFP 105 (FIG. 1) to a number of recipients by posting the digital document on the web server 203 (FIG. 1) with various access permissions for the recipients. Beginning with block 253, the digital sender service 201 waits for a new digital document from the MFP 105 to be posted on the web server 203. Assuming a digital document is received with the various email addresses 141 (FIG. 1) of the intended recipients, the digital sender service 201 moves to block 256. In block 256 the destination email addresses 141 are retrieved from the memory 165 where they were initially stored after arriving from the MFP 105.

Then, in block 259 the first destination email address 141 is determined. Thereafter, in block 263 the destination email address 141 is transmitted to the directory server 120 (FIG. 1) with a request for a security identifier that is associated with the destination email address 141. In this manner, the destination email address 141 is mapped to a corresponding security identifier 143 (FIG. 1). The request is in a format, for example, that is compatible with a lightweight directory access protocol (LDAP) or other similar protocol. Next, in block 266 it is determined if a security identifier 143 has been obtained for the last destination email address 141. If not, then the digital sender service 201 moves to block 269 in which the next destination email address 141 is identified. Thereafter, the digital sender service 201 reverts back to block 263 to retrieve the security identifier 143 associated with the current destination email address 141.

Assuming that the last security identifier 143 has been obtained from the directory server 120, the digital sender service 201 proceeds to block 273 in which the digital document to be posted is transformed into a web document or other format is for placement on the web server 203. Then, in block 276 the digital document in the web document format is copied to the web server 203 where it is accessible by devices on the network 125 and to devices on an external network is applicable. Thereafter, in block 279 read file privileges are assigned to the digital document. This is accomplished, for example, by associating the security identifiers 143 with the digital document, thereby indicating the access privileges to the digital document from the network 125. Specifically, the security identifiers 143 are listed, for example, in appropriate locations of an access control list associated with the digital document.

Then, in block 283, an email message is generated for each of the intended recipients of the digital document. The uniform resource locator associate with the digital document stored on the web server 203 is associated with each of the email messages. The email messages are then transmitted to the destination email addresses 141 that were associated with the digital document so that the chosen individuals could access the digital document at a time convenient to themselves. Thereafter, the digital sender service 201 reverts back to block 253 to wait for the arrival of the next digital document and its associated destination addresses 141.

Although the digital sender 195 and the digital sender service 201 of the present invention are embodied in software executed by general purpose hardware as discussed above, as an alternative the digital sender 195 and/or the digital sender service 201 may also be embodied in dedicated hardware or a combination of software/general purpose hardware and dedicated hardware. If embodied in dedicated hardware, the digital sender 195 and/or the digital sender service 201 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

With reference to FIGS. 2 and 3, the flow charts of FIGS. 2 and 3 show the architecture, functionality, and operation of an implementation of the digital sender 195 and the digital sender service 201. If embodied in software, each block may represent a module, segment, or portion of code that comprises one or more executable instructions to implement the specified logical function(s). If embodied in hardware, each block may represent a circuit or a number of interconnected circuits to implement the specified logical function(s). Although the flow charts of FIGS. 2 and 3 show a specific order of execution, it is understood that the order of execution may differ from that which is depicted. For example, the order of execution of two or more blocks may be scrambled relative to the order shown. Also, two or more blocks shown in succession in FIGS. 2 and 3 may be executed concurrently or with partial concurrence. It is understood that all such variations are within the scope of the present invention. Also, the flow charts of FIGS. 2 and 3 are relatively self-explanatory and are understood by those with ordinary skill in the art to the extent that software and/or hardware can be created by one with ordinary skill in the art to carry out the various logical functions as described herein.

Also, the digital sender 195 and the digital sender service 201 can be embodied in any computer-readable medium for use by or in connection with an instruction execution system such as a computer/processor based system or other system that can fetch or obtain the logic from the computer-readable medium and execute the instructions contained therein. In the context of this document, a “computer-readable medium” can be any medium that can contain, store, or maintain the digital sender 195 or the digital sender service 201 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

Many variations and modifications may be made to the above-described embodiment(s) of the invention without departing substantially from the spirit and principles of the invention. All such modifications and variations are intended to be included herein within the scope of the present invention.

What is claimed is:

1. A method in for transferring a digital document, comprising the steps of:
mapping from a number of destination addresses to a respective number of security identifiers via a directory server;
adding a number of access privileges to the digital document in a computer system via a network using the security identifiers; and
posting the digital document on a server accessible via the network.

2. The method of claim 1, further comprising the steps of:
generating a number of email messages in the computer system to be transmitted to the number of destination addresses, respectively;
associating a uniform resource locator of the digital document on the network with each of the email messages; and
transmitting the email messages to the respective destination addresses on the network.

3. The method of claim 1, wherein the step of mapping from the number of destination addresses to the respective number of security identifiers via the directory server further comprises the step of transmitting each of the destination addresses to the directory server along with a request for the security identifier associated therewith.

4. The method of claim 3, wherein the step of adding the number of access privileges to the digital document in a computer system via the network using the security identifiers further comprises the step of listing the security identifiers received from the directory server in an access control list associated with the digital document.

5. The method of claim 4, further comprises the step of authenticating a client device attempting to access the digital document via the network.

6. A system for transferring a digital document, comprising:
a processor circuit having a processor and a memory;
a digital sender service stored on the memory and executable by the processor, the digital sender service comprising:
logic to map from a number of destination addresses to a respective number of security identifiers;
logic to add a number of access privileges to the digital document via a network using the security identifiers; and
logic to post the digital document on a server accessible via the network.

7. The system of claim 6, wherein the digital sender service further comprises logic to generate and transmit a number of email messages to a corresponding number of destination addresses on the network, wherein each of the email messages includes a uniform resource locator of the digital document on the network.

8. The system of claim 6, wherein the logic to map from the number of destination addresses to the respective number of security identifiers further comprises logic to transmit each of the destination addresses to the directory server along with a request for the security identifier associated therewith.

9. The system of claim 8, wherein logic to add a number of access privileges to the digital document via a network using the security identifiers further comprises logic to list the security identifiers received from the directory server in an access control list associated with the digital document.

10. The system of claim 9, wherein the digital sender service further comprises logic to authenticate a client device attempting to access the digital document via the network.

11. A system for transferring a digital document, comprising:
means for mapping from a number of destination addresses to a respective number of security identifiers;
means for adding a number of access privileges to the digital document via a network using the security identifiers; and
means for posting the digital document on a server accessible via the network.

12. The system of claim 11, further comprising means for generating and transmitting a number of email messages to a corresponding number of destination addresses on the network, wherein each of the email messages includes a uniform resource locator of the digital document on the network.

13. The system of claim 11, wherein the means for mapping from the number of destination addresses to the respective number of security identifiers further comprises means for transmitting each of the destination addresses to the directory server along with a request for the security identifier associated therewith.

14. The system of claim 13, where in the means for adding the number of access privileges to the digital document via the network using the security identifiers further comprises means for listing the security identifiers received from the directory server in an access control list associated with the digital document.

15. A computer program embodied on a computer readable medium for transferring a digital document, comprising:
logic to map from a number of destination addresses to a respective number of security identifiers;
logic to add a number of access privileges to the digital document via a network using the security identifiers; and
logic to post the digital document on a server accessible via the network.

16. The computer program embodied on a computer readable medium of claim 15, further comprising:
logic to generate a number of email messages to be transmitted to the number of destination addresses, respectively;
logic to associate a uniform resource locator of the digital document on the network with each of the email messages; and
logic to transmit the email messages to the respective destination addresses on the network.

17. The computer program embodied on a computer readable medium of claim 15, wherein the logic to map from the number of destination addresses to the respective number of security identifiers further comprises logic to transmit each of the destination addresses to the directory server along with a request for the security identifier associated therewith.

18. The computer program embodied on a computer readable medium of claim 17, wherein logic to add the number of access privileges to the digital document via the network using the security identifiers further comprises logic to list the security identifiers received from the directory server in an access control list associated with the digital document.
